(19) United States
(12) Patent Application Publication
(10) Pub. No.: US 2003/0124036 A1
(43) Pub. Date: Jul. 3, 2003

(54) Retainer for buttressing an element and a method for producing the retainer

(76) Inventors: Kevin J. Low, Wethersfield, CT (US); Warren F. Smith, Branford, CT (US); William C. Pfefferle, Madison, CT (US); Subir Roychoudhury, Madison, CT (US)

Correspondence Address: McCormick, Paulding & Huber, City Place II, 185 Asylum Street, Hartford, CT, 06103-3402, US

(21) Appl. No.: 10/040,144

(22) Filed: Jan. 3, 2002

(51) Int. Cl. F01N 3/28; B01D 53/34

(52) U.S. Cl. 422/177; 422/171; 422/180; 55/501

(57) ABSTRACT

The present invention is a retainer and a method of manufacture therefor that can incorporate the ability to condition the flow of a fluid therethrough. The retainer defines an bearing surface for buttressing an element having a fluid flowing therethrough. The retainer is comprised of a plurality of members that if given the proper aspect ratio can condition the flow of a fluid.

### FIELD OF THE INVENTION

The present invention is generally directed to a retainer for maintaining the position of an element and more specifically relates a retainer for buttressing an element wherein the element is subjected to forces applied in substantially one direction.

### BACKGROUND OF THE INVENTION

Catalytic reactors are used in numerous applications, such as automobiles, e.g. a catalytic converter, to facilitate chemical reactions. A catalytic reactor facilitates a chemical reaction by the use of a catalyst. The catalyst accelerates certain reaction paths for the chemical reaction thereby allowing for in some cases the chemical reaction to occur, or occur more rapidly.

The catalyst must be positioned such that the chemicals to be reacted, i.e. reactants, encounter each other and the catalyst simultaneously. In a majority of catalytic reactors, the catalyst remains stationary and the chemicals to be reacted flow over the catalyst. In these types of reactors in order for the reactants to encounter the catalyst, the catalyst must be distributed over a surface. Catalyst not on or at the surface cannot support the reaction.

Catalyst is sometimes positioned on the surface of a material, typically referred to as a substrate. Substrates vary widely in shape and composition and can include, inter alia, pellets, monoliths, foams, and screens. There are numerous methods of positioning the catalyst on the substrate from coating to alloying. In essence, the substrate provides a support over which the catalyst can be positioned.

It is known that substrate defining a plurality of passages or channels extending therethrough and being short in length, referred to by those skilled in the art as short channel substrate elements, such as screens are excellent for certain catalytic reactors. A problem, however, is that optimization of the reactor design sometimes dictates substrate elements that lack the necessary structural integrity to function properly within the flow stream to which the substrate elements will be subjected. More specifically, when such a substrate element is placed within a flow path and subjected to the forces associated with a fluid passing therethrough, the substrate element may deform. In addition, in catalytic reactors where substrate elements are utilized, retention of the substrate elements can be problematic. As discussed above, optimum substrate elements can lack structural integrity, therefore tending to deform thereby becoming dislodged from a holding mechanism.

Based on the foregoing, it is the general objective of the present invention to provide a solution that overcomes the problems and drawbacks associated with the prior art.

### SUMMARY OF THE INVENTION

The invention is a retainer for buttressing an element subjected to forces applied in substantially one direction. The retainer includes a support with a plurality of members extending therefrom. The members are spaced apart from the next successive member and each member defines an abutment surface. The abutment surfaces define a bearing surface adapted to engage the element.

The present invention can also be configured as a retainer including a support with at least one member extending therefrom. Further, the support defines a deflection means adjacent the at least one member whereby the member is permitted to expand and contract independently of the support.

In the preferred embodiment, the element, such as a screen being used as a substrate for a catalyst, is employed in a catalytic reactor. The substrate is designed based upon the application, and multiple substrates could be bundled into a single unit. In use, the substrate(s) are retained within a housing and a fluid is forced through the substrate(s). In some cases, the structural integrity of the substrate will be such that the substrate will not have sufficient structural integrity to remain where held unless buttressed. In the present invention, the bearing surface of the retainer engages the substrate and restrains the substrate.

In an enhancement of the device, the bearing surface and the element can cooperate to give the element a generally fair contour. A generally fair contour means that the element is straight or smoothly curving having no sudden angular deviation(s). As those skilled in the art of catalytic reactor design will appreciate, the ability of the retainer to buttress a substrate such that the substrate adopts a generally fair contour is a function of the spacing of the abutment surfaces of the members and the structural integrity of the substrate.

The members can be of any shape with spacing therebetween being dependent upon the structural integrity of the element. In one embodiment, each member is of a regular solid shape and positioned for maximum resistance to bending in the direction of the force. For a member having a rectangular cross-section, maximum resistance to bending is achieved when the width exceeds the thickness wherein the thickness is the surface that first comes into contact with the fluid. Based on the angle defined between the width and the support, the member can have any orientation, including but not limited to perpendicular to the flow. If the angle is between 60 and 120 degrees the member is aerodynamically oriented to minimize flow separation and pressure drop. Successive members can be positioned relative to each other at any angle and can be generally parallel if desired.

In yet another aspect of the invention, the members can have the ability to act as a flow conditioner. The members if properly proportioned can act to redirect the fluid as the fluid exits from the element. As indicated above the members have a thickness and a width. The thickness and width can be used to define an aspect ratio, which is defined as the width divided by the thickness. The ability to turn the flow depends upon flow impingement on the surfaces defines by the width. Thus, the aspect ration is an important design feature. Preferably, the aspect ratio should be greater than about three.

The members extend from a support. The support can be of almost any shape. Closed regular shapes such as circles, squares and trapezoids as well as irregular shapes are considered within the scope of the invention. Open shapes are also considered within the scope of the invention. Open shapes include but are not limited to non-parallel bodies, parallel bodies, and crossing bodies. A surface of the support may also be a portion of the bearing surface.

In certain applications, the retainer might have a hinge permitting the retainer to bend around both sides of an element or elements. In this case, the retainer might have different structural characteristics depending upon which side of the element it is positioned.

One application for the retainer of the present invention is within a catalytic reactor. One such example is a catalytic reactor having a reactor housing having an interior and a cross-section. For simplicity, consider the reactor housing to be a cylinder and the cross-section to be circular; however the invention should not be considered so limited as other shapes could be used. The retainer is sized to fit within the cross-section of the reactor housing. The cross-section of the retainer should be slightly less than the cross-section of the reactor housing. The slightly less requirement allows the retainer to be slipped into the reactor housing and for expansion of the retainer when heated by the catalytic reaction.

In the case where a pulsing flow is anticipated two retainers are used and positioned within the reactor housing such that the respective bearing surfaces are opposed, otherwise one retainer can be used. The bearing surface preferably spans the entire cross-section but may span less. The retainers are held within the reactor housing by an inlet housing and an outlet housing. The inlet and outlet housings are sized to slip into the reactor housing and impinge upon the support of the appropriate retainer. The inlet and outlet housings then are connected to the reactor housing thereby securing the retainers and substrate within the reactor housing, such that the retainers are in essence floating within the reactor housing.

The retainer can be made for a single plate of material with the pattern for the members and support cut into the plate, such as by stamping. The members are then rotated to define the bearing surface. Where the supports are to be integrated into the bearing surface, the members can have an offset, created by a pair of notches, that permit the abutment portion of the members to align with a surface of the support. As previously indicated, advantageously the member has a width that is greater than the thickness such that when the member is rotated the moment of inertia of the member is greatest in the direction of flow.

### BRIEF DESCRIPTION OF THE DRAWINGS

FIG. 1 is a perspective view of a first embodiment of the present invention.

FIG. 2 is a first potential cross-section of the embodiment of FIG. 1 wherein the members and a surface of the support define the bearing surface.

FIG. 3 is a second potential cross-section of the embodiment of FIG. 1 wherein only the members define the bearing surface.

FIG. 4 is a third potential cross-section of the embodiment of FIG. 1 wherein only the members define the bearing surface.

FIG. 5 is a top view of a second embodiment of the present invention.

FIG. 6 is a top view of a third embodiment of the present invention prior to rotation of the members.

FIG. 7 is a top view of the third embodiment of depicted in FIG. 5 after rotation of the members.

FIG. 8 is a cross-sectional view of a catalytic reactor employing the third embodiment of the invention depicted in FIG. 6.

### DETAILED DESCRIPTION

As shown in FIG. 1, the retainer generally designated by the reference number 10 is comprised of a support 12 that is a pair of bodies 14. Extending between the bodies 14 is a plurality of members 16. Deflection means 17 is provided in the support 12 permitting the expansion and contraction of a member 16 without deformation of the support 12. As depicted, the deflection means is a slot with a stress release geometry. The slot is positioned adjacent a member 16.

FIG. 2, shows a first potential cross-section of FIG. 1 taken along line A-A. In FIG. 2 the member 16 has an abutment surface 18 that defines bearing surface 20. The bearing surface 20 incorporates a surface 22 of the bodies 14. In this embodiment due to the shape of the members 16 an other bearing surface 24 is also defined. Due to symmetry of the members 16 the definition of two bearing surfaces will not be atypical, but the invention should not be considered so limited.

FIG. 3 shows a second potential cross-section of FIG. 1 taken along line A-A. In this cross-section the bearing surface 26 defined by the abutment surfaces 18 do not incorporate the surface 22 of the support 12.

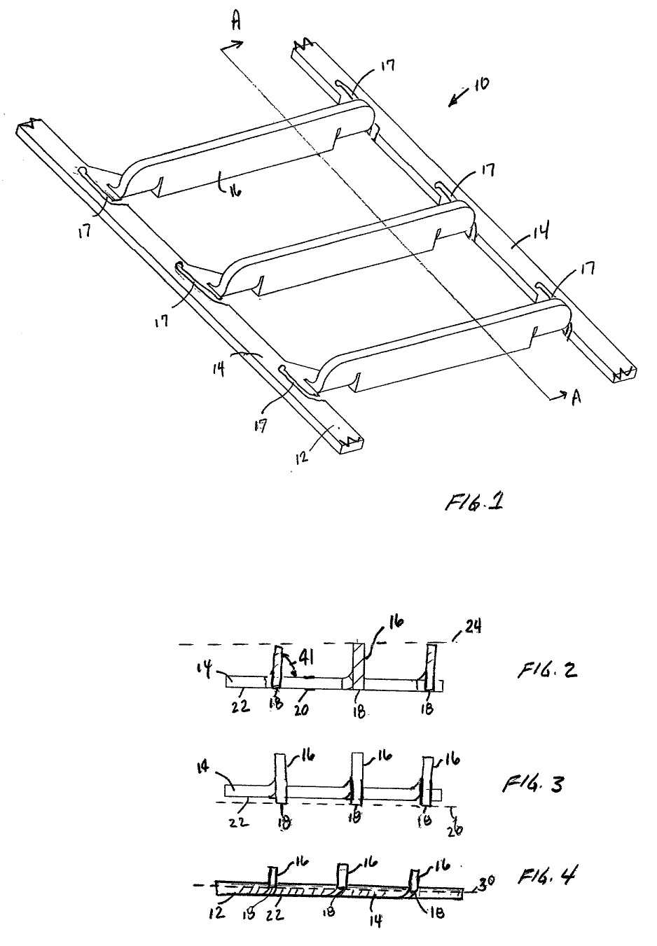

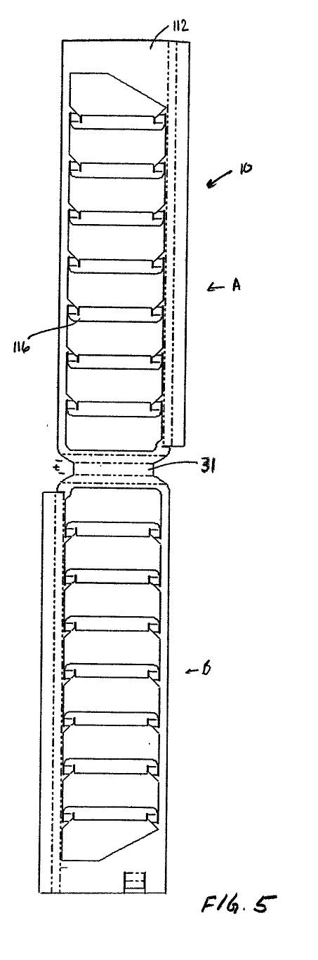

FIG. 4 shows a third potential cross-section of the retainer in FIG. 1 taken along line A-A. Like the second potential cross-section, the abutment surfaces 18 to not incorporate any surface of the support 12. It should be noted, however that the bearing surface 30 is within support 12, i.e. between bodies 14.

While all the bearing surfaces 20, 26, and 30 are shown as being generally planer, this is not a requirement of the invention. The bearing surface can be of any contour.

In the case where the element (not shown) and the bearing surface 20, 26, 28 and 30 cooperate such that the element adopts a fair contour when engaged with the bearing surface, the adoption of an element of a fair contour will be a function of the spacing of the members and the structure of the element. In other words, for more flexible elements, the members will have to be relatively closer than for less flexible ones.

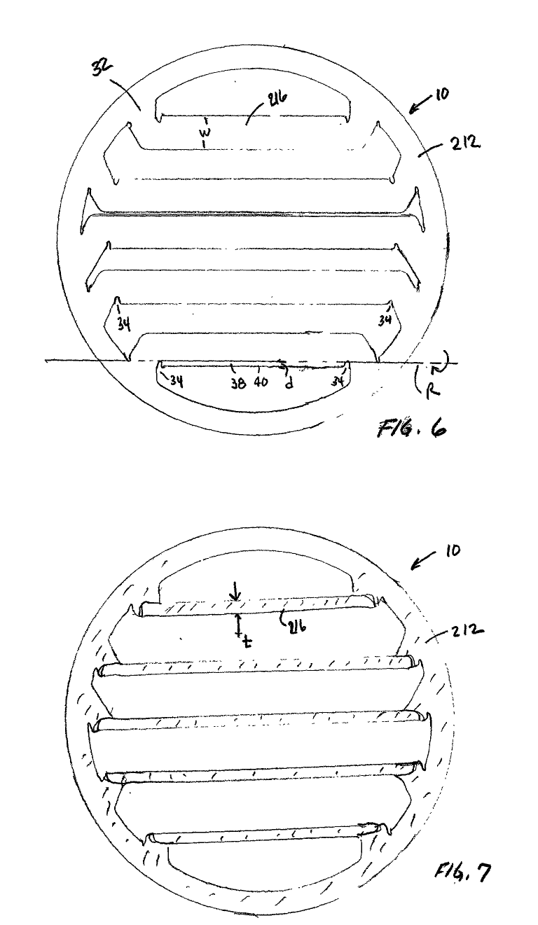

FIG. 5 is a top view of a second embodiment of the present invention. Therefore, like reference numbers preceded by the number 1 are used to indicate like elements. The support 112 is a closed shape. The members 116 extend across the support 112. A hinge 31 is positioned within the support 112. The hinge 31 has a thickness t that permits a certain number of elements (not shown) to be placed between the two halves generally designated A and B after which the two halves A and B are folded to be roughly parallel securing the elements therebetween. Depending upon the number of bearing surfaces (see FIGS. 2 and 3), the hinge could work in either direction or only one.

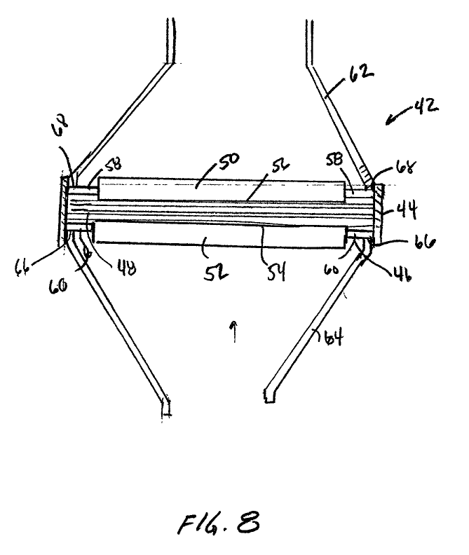

FIGS. 6 and 7 depict yet another embodiment of the present invention. Therefore, like reference numbers preceded by the number 2 are used to indicate like elements. In this embodiment the support 212 is cylindrical. Beginning with FIG. 6, the retainer is being manufactured from a plate 32 having a thickness t, see FIG. 7. The plate has been stamped, but any cutting method is acceptable, to define the support 212 and members 116. The member 216 has a width w that is greater than the thickness of the plate thereby defining an aspect ratio greater than 1. Referring to FIG. 7, the aspect ratio of the member 216 is the width w divided by the thickness t. If flow conditioning was desired the aspect ratio would have to be greater than about 3.

Continuing with FIG. 6, each member 216 has a pair of notches 34 that define an offset 38. In this embodiment, it is the intention that the surface of the member 216 and a surface of support 212 define the bearing surface (such as bearing surface 20 in FIG. 2). The offset 38 has a depth d which is the thickness of the plate 32. As a result when the member 116 is rotated about an axis R, the abutment surfaces 40 will align with a surface of the support 212, similarly to bearing surface 20 in FIG. 2.

FIG. 7 shows the member 216 rotated sufficiently to be perpendicular, i.e. 90 degrees, to the support 212. It should be noted that rotation of member 216 could have been to any angle 41 (see FIG. 2) greater than zero. If the member 216 is to have an aerodynamic orientation, the angle 41 should be between 60 and 120 degrees.

FIG. 8 depicts a catalytic reactor generally denoted by reference number 42. The catalytic reactor 42 is comprised of a reactor housing 44 having an interior 46 and a cross-section. Positioned within the reactor housing is a plurality of elements 48, i.e. catalytically active screens, positioned between retainers 50 and 52. The retainers 50 and 52 have bearing surfaces 54 and 56 and supports 58 and 60. It should be noted that the bearing surfaces 54 and 56 extend substantially across the cross section of the reactor housing 44. The retainers 50 and 52 also extend substantially across the reactor housing 44 with clearance provided for expansion of the retainers 50 and 52 during operation.

The retainers 50 and 52 are secured in the reactor housing 44 by an inlet housing 62 and an outlet housing 64. The inlet and outlet housings 62 and 64 are designed to slid into reactor housing 44 and contact the supports 58 and 60 of the retainers 50 and 52 on impingement surfaces 66 and 68. After contact, the inlet and outlet housings are connected to the reactor housing 44. This structure permits the elements 48, i.e. which are catalytic, to be secured by two elements that are permitted to float within the reactor housing 44.

The catalytic reactor 42 utilizes two retainers 50 and 52 when pulsating fluid flow through the reactor is anticipated. If the fluid flow is unidirectional, one retainer could be used. If this were the case, the appropriate housing, inlet or outlet, could impinge the elements. It is understood that the while direct impingement is shown, intermediate structures such as rings could be used and not deviate from the spirit of the invention.

While preferred embodiments have been shown and described, various modifications and substitutions may be made thereto without departing from the spirit and scope of the invention such as each retainer does not have to have two bearing surfaces. Accordingly, it is to be understood that the present invention has been described by way of illustration and not limitation.

What is claimed is:

1. A retainer for buttressing an element subjected to forces applied substantially in one direction, the retainer comprising:
a support;
a plurality of members extending from the support, each member being spaced apart from the next successive member and defining an abutment surface; and wherein
the abutment surfaces of the plurality of members defining a bearing surface adapted to engage the element when the forces are applied.

2. The retainer of claim 1 wherein the bearing surfaces and the element cooperate such that the element adopts a generally fair contour when the forces are applied.

3. The retainer of claim 2 wherein the member has an aspect ratio greater than 3.

4. The retainer of claim 2 wherein the support has a surface and the surface is part of the abutment surface.

5. The retainer of claim 1 wherein the member has an aspect ratio greater than 3.

6. The retainer of claim 5 wherein the member has an aerodynamic orientation to the support.

7. The retainer of claim 1 wherein the housing defines a hinge, the hinge defining a first and second part.

8. A method of manufacturing a retainer, the method comprising the steps of:
providing a plate;
cutting in the plate a pattern defining a support, a plurality of members extending from the support, each member being spaced apart from the next successive member; each member having an abutment surface and
rotating each member thereby aligning the abutment surfaces defining a bearing surface, the bearing surface being adapted to engage the element.

9. The method of claim 8 wherein the abutment surface cooperates with the element such that the element adopts a fair contour when the forces are applied.

10. The method of claim 8 wherein the member has an aspect ratio greater than 3.

11. The method of claim 10 wherein the member is rotated to an angle of between 60 and 120 degrees relative to the support.

12. The method of claim 8 wherein in the cutting step an offset is created permitting an edge of the member to align with a surface of the support after rotation of the member.

13. A catalytic reactor comprising:
a reactor housing having an interior and a cross-section;
a retainer comprising a support, a plurality of members extending from the support, each member being spaced apart from the next successive member and having an abutment surface, the abutment surfaces defining a bearing surface, the bearing surface being sufficient to extend substantially across a relevant portion of the cross-section, the retainer having a cross-section slightly less than the cross-section of the housing, the retainers positioned within the interior across the cross-section such that the abutment surfaces are opposed;
a catalytic element positioned between the retainers;
an inlet housing engaging the reactor housing and defining an impingement surface for the support of the retainer, and
an outlet housing engaging the reactor housing and defining an impingement surface for the support of element.

14. The catalytic reactor of claim 13 wherein the abutment surfaces and the element cooperate such that the element adopts a generally fair contour when the forces are applied.

15. The catalytic reactor of claim 14 wherein the member has an aspect ratio greater than 3.

16. The catalytic reactor of claim 14 wherein the support has a surface and the surface is part of the bearing surface.

17. The catalytic reactor of claim 13 wherein the member has an aspect ratio greater than 3.

18. The catalytic reactor of claim 16 wherein the member has an aerodynamic orientation to the support.

19. The catalytic reactor of claim 13 further comprising an other retainer positioned between the outlet housing and the elements.

20. A retainer for buttressing an element subjected to forces applied substantially in one direction, the retainer comprising:
a support having a surface;
at least one member extending from the support, each member defining an abutment surface; and wherein
the support defines deflection means adjacent at least one member such that the member can expand and contract independently of the support.

21. The retainer of claim 20 wherein the surface and the abutment surface align.

22. A catalytic reactor comprising:
a reactor housing having an interior and a cross-section;
a retainer comprising a support having a surface;
at least one member extending from the support, each member defining an abutment surface; and wherein the support defines deflection means adjacent at least one member such that the member can expand and contract independently of the support, the retainer having a cross-section slightly less than the cross-section of the housing, the retainers positioned within the interior across the cross-section such that the abutment surfaces are opposed;
a catalytic element positioned between the retainers;
an inlet housing engaging the reactor housing and defining an impingement surface for the support of the retainer, and
an outlet housing engaging the reactor housing and defining an impingement surface for the support of element.

24. The retainer of claim 23 wherein the surface and the abutment surface align.
